(19) United States
(12) Patent Application Publication
(10) Pub. No.: US 2020/0364052 A1
(43) Pub. Date: Nov. 19, 2020

(54) BRANCH PENALTY REDUCTION USING MEMORY CIRCUIT

(71) Applicant: WESTERN DIGITAL TECHNOLOGIES, INC., San Jose, CA (US)

(72) Inventors: Vijay Chinchole, Bangalore (IN); Naman Rastogi, Bangalore (IN); Sonam Agarwal, Bangalore (IN); Daniel J. Linnen, Naperville, IL (US)

(21) Appl. No.: 16/679,412

(22) Filed: Nov. 11, 2019

Related U.S. Application Data
(63) Continuation-in-part of application No. 16/412,968, filed on May 15, 2019.

(51) Int. Cl. G06F 9/38

(52) U.S. Cl. CPC G06F 9/381; G06F 9/3818

(57) ABSTRACT

A memory circuit included in a computer system stores multiple program instructions in program code. In response to fetching a loop boundary instruction, a processor circuit may store, in a loop storage circuit, a set of program instructions included in a program loop associated with the loop boundary instruction. In executing at least one iteration of the program loop, the processor circuit may retrieve the set of program instructions from the loop storage circuit.

### CROSS REFERENCE TO RELATED APPLICATION

This application is a continuation-in-part of co-pending U.S. patent application Ser. No. 16/412,968, filed on May 15, 2019, which is hereby incorporated by reference in its entirety.

### BACKGROUND

### Technical Field

This disclosure relates to processing in computer systems and more particularly to executing program instructions that include conditional branch instructions.

### Description of the Related Art

Modern computer systems may be configured to perform a variety of tasks. To accomplish such tasks, a computer system may include a variety of processing circuits, along with various other circuit blocks. For example, a particular computer system may include multiple microcontrollers, processors, or processor cores, each configured to perform respective processing tasks, along with memory circuits, mixed-signal or analog circuits, and the like.

In some computer systems, different processing circuits may be dedicated to specific tasks. For example, a particular processing circuit may be dedicated to performing graphics operations, processing audio signals, managing long-term storage devices, and the like. Such processing circuits may include customized processing circuit, or general-purpose processor circuits that execute program instructions in order to perform specific functions or operations.

In various computer systems, software or program instructions to be used by a general-purpose processor circuit may be written in a high-level programming language and the compiled into a format that is compatible with a given processor or processor core. Once compiled, the software or program instructions may be stored in a memory circuit included in the computer system, from which the general-purpose processor circuit or processor core can fetch particular instructions.

### SUMMARY OF THE EMBODIMENTS

Various embodiments for a computer system that includes a processor circuit, a memory circuit, and a loop storage circuit are disclosed. Broadly speaking, the processor circuit may be configured to fetch, from the memory circuit, a particular program instruction from the plurality of program instructions. In response to a determination that the particular program instruction is a loop boundary instruction, the processor circuit may be further configured to store, in the loop storage circuit, a set of program instructions included in a program loop associated with the particular program instruction. The processor circuit may also be configured to execute at least one iteration of the program loop subsequent to an execution of an initial iteration of the first program loop. To execute the at least on iteration of the first program loop, the processor circuit may be further configured to retrieve the first set of program instructions from the first loop storage circuit.

### BRIEF DESCRIPTION OF THE DRAWINGS

FIG. 1 is a block diagram of an embodiment of a computer system.

FIG. 2 illustrates a block diagram of an embodiment of a processor circuit.

FIG. 3 illustrates a schematic diagram of an embodiment of a memory circuit.

FIG. 4 is a block diagram of an embodiment of a multi-bank memory array.

FIG. 5 depicts example waveforms associated with fetching instructions.

FIG. 6 illustrates a flow diagram depicting an embodiment of a method for operating a computer system.

FIG. 7 illustrates a flow diagram depicting an embodiment of a method for generating compressed program code.

FIG. 8 illustrates a flow diagram depicting an embodiment of a method for operating a computer system using compacted program code.

FIG. 9 is a block diagram depicting overlapping code within a graph representation of program code.

FIG. 10A is a block diagram depicting nested links within a graph representation of program code.

FIG. 10B is a block diagram depicting direct links within a graph representation of program code.

FIG. 11A is a block diagram depicting long calls within a graph representation of program code.

FIG. 11B is a block diagram depicting re-ordered subroutines with a graph representation of program code.

FIG. 12 is a block diagram of another embodiment of a computer system.

FIG. 13 is a block diagram of another embodiment of a processor circuit.

FIG. 14 is a block diagram of a content-addressable memory circuit.

FIG. 15A is a chart depicting execution of program instructions with a conditional branch.

FIG. 15B is a chart depicting execution of program instructions with a conditional branch using a content-addressable memory circuit.

FIG. 16 illustrates a flow diagram depicting an embodiment of a method for tagging loops of program instructions in program code.

FIG. 17 illustrates a flow diagram depicting an embodiment of a method for operating a content-addressable memory.

FIG. 18 is a block diagram of one embodiment of a storage subsystem for a computer system.

FIG. 19 is a block diagram of another embodiment of a computer system.

FIG. 20 is a block diagram depicting computer system coupled together using a network.

While the disclosure is susceptible to various modifications and alternative forms, specific embodiments thereof are shown by way of example in the drawings and will herein be described in detail. It should be understood, however, that the drawings and detailed description thereto are not intended to limit the disclosure to the particular form illustrated, but on the contrary, the intention is to cover all modifications, equivalents and alternatives falling within the spirit and scope of the present disclosure as defined by the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include,” “including,” and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. § 112, paragraph (f) interpretation for that unit/circuit/component. More generally, the recitation of any element is expressly intended not to invoke 35 U.S.C. § 112, paragraph (f) interpretation for that element unless the language “means for” or “step for” is specifically recited.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. The phrase “based on” is thus synonymous with the phrase “based at least in part on.”

### DETAILED DESCRIPTION OF EMBODIMENTS

In computer systems that employ general-purpose processor circuits, software programs that include multiple program instructions may be used in order to allow the general-purpose processor circuits to perform a variety of functions, operations, and tasks. Such software programs may be written in a variety of high or low-level programming languages that are compiled prior to execution by the general-purpose processor circuits. The compiled version of the software program can be stored in a memory circuit from which a processor circuit may retrieve, in a processor referred to as “fetching,” individual ones of the program instructions for execution.

During development of a software program, certain sequences of program instructions may be repeated through the program code of the software program. To reduce the size of the program code, such repeated sequences of program instructions may be converted to a subroutine or macro. When a particular sequence of program instructions is needed in the program code, an unconditional flow control program instruction may be inserted into the program code, which instructs the processor circuit to jump to a location in the program code corresponding to the subroutine or macro that includes the particular sequence of program code. When execution of the sequence of program code is complete, the processor circuit returns to the next program instruction following the unconditional flow control program instruction.

Unconditional flow control instructions may, for example, include call instructions. When a call instruction is executed, a processor circuit transfers the return address to a storage location (commonly referred to as a “stack”) and then begins fetching, and then executing, instructions from the address location in memory specified by the call instruction. The processor circuit continues to fetch instructions along its current path until a return instruction is encountered. Once a return instruction is encountered, the processor retrieves the return address from the stack, and begins to fetch instructions starting from a location in memory specified by the return address. In other embodiments, management of the flow of program execution may be performed using other types of unconditional flow control instructions, such as unconditional branch instructions. Unlike call instructions, unconditional branch instructions may not directly modify a call/return stack, for example by pushing a return address to the stack. In some embodiments, unconditional branch instructions may be combined with other types of instructions to perform call/return stack manipulation, thereby effectively synthesizing the behavior of call and return instructions. In other embodiments, depending on the selected programming model, unconditional branch instructions may directly implement flow control by explicitly encoding destination addresses without relying on a call/return stack.

The process of altering the flow of control of program execution can influence execution performance. In particular, the process of storing the return address on the stack, fetching instructions from a subroutine, and then retrieving the return address from the stack can consume multiple clock cycles. For example, five clock cycles may be consumed in the overhead associated with calling a subroutine or macro. The time penalty associated with the overhead in calling a subroutine or macro can limit performance of a processor circuit and slow operation of a computer system. The embodiments illustrated in the drawings and described below may provide techniques for compressing (also referred to as “compacting”) program code by identifying repeated sequences of program instructions across different subroutines or macros, replacing such sequences with flow control instructions, and reducing the cycle overhead associated with execution of the flow control instructions to maintain performance of a processor circuit.

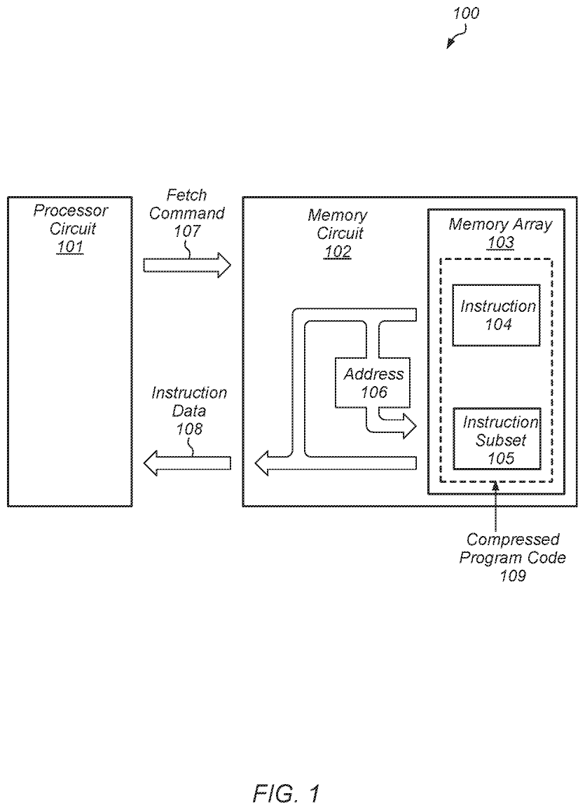

A block diagram depicting an embodiment of computer system is illustrated in FIG. 1. As illustrated, computer system 100 includes processor circuit 101 and memory circuit 102, which includes memory array 103 configured to store compacted program code 109. In various embodiments, memory circuit 102 is external to processor circuit 101. As used herein, external refers to processor circuit 101 and memory circuit 102 being included on a same integrated circuit and coupled by a communication bus, processor circuit 101 included on an integrated circuit different from one that includes memory circuit 102, or any other suitable arrangement where processor circuit 101 and memory circuit 102 are distinct circuits. As described below in more detail, compacted program code 109 may include a plurality of program instructions (or simply “instructions”), including instruction 104 and instruction subset 105. Such instructions when received and executed by processor circuit 101, result in processor circuit 101 performing a variety of operations including the management of access to one or more memory devices.

Processor circuit 101 may be a particular embodiment of a general-purpose processor configured to generate fetch command 107. As described below in more detail, processor circuit 101 may include a program counter or other suitable circuit, which increments a count value each processor cycle. The count value may then be used to generate an address included in fetch command 107. The address may, in various embodiments, correspond to a storage location in memory array 103, which stores instruction 104.

As described below, memory circuit 102 may include multiple memory cells configured to store one or more bits. Multiple bits corresponding to a particular instruction are stored in one or more memory cells, in order to store compacted program code 109 into memory array 103. As illustrated, memory circuit 102 is configured to retrieve instruction 104 of the plurality of program instructions from the memory array based, at least in part, on receiving fetch command 107. In various embodiments, memory circuit 102 may extract address information from fetch command 107, and use the extracted address information to activate particular ones of the multiple memory cells included in memory array 103 to retrieve bits corresponding to instruction 104.

In response to a determination that the instruction 104 is a particular type of instruction, memory circuit 102 is further configured to retrieve, from memory array 103, instruction subset 105 beginning at address 106, which is included in the instruction 104. The particular type of instruction may include an unconditional flow control instruction to a particular instance of a sequence of instructions included in instruction subset 105. As used herein, an unconditional flow control instruction is an instruction which changes the flow in which instructions are executed in program code by changing a location in memory from which instructions are fetched. For example, unconditional flow control instructions may include call instruction, jump instructions, unconditional branch instructions, and the like.

As described below in more detail, such unconditional flow control instructions may have been added into compacted program code 109 to replace instances of repeated sequences of instructions that were duplicated across different subroutines or macros in program code. By replacing duplicate instances of the repeated sequences with respective unconditional flow control instructions directed to a single copy of the sequence of instructions, the size of the program code may be reduced or “compacted.”

Since memory circuit 102 is configured to detect when such unconditional flow control instructions have been retrieved from memory array 103 and, in turn, retrieve the sequences of instruction identified by the unconditional flow control instructions, processor circuit 101 does not have to determine the destination address for the unconditional flow control instruction and begin fetching instructions using the new address. As such, the latency associated with the use of an unconditional flow control instruction may be reduced, and the efficiency of pre-fetching instructions may be improved. It is noted that in some embodiments, memory circuit 102 may be considered to effectively expand previously compacted code in a manner that is mostly or completely transparent to processor circuit 101. That is, memory circuit 102 may decode certain instructions on behalf of (and possibly instead of) processor circuit 101, thus effectively extending the decode stage(s) of processor circuit 101's execution pipeline outside of processor circuit 101 itself, for at least some instructions. Thus, for a stream of instructions, both memory circuit 102 and processor circuit 101 operate cooperatively to fetch, decode, and execute the instructions, with at least some decoding operations occurring within memory circuit 102. In some cases, for certain instruction types (e.g., unconditional flow control instructions), memory circuit 102 and processor circuit 101 may operate cooperatively, with the memory circuit 102 decoding and executing the instructions, and processor circuit 101 managing program counter values and other bookkeeping operations.

Memory circuit 102 is also configured to send instruction subset 105 (indicated as “instruction data 108”) to processor circuit 101. In some cases, memory circuit 102 may additionally send instruction 104 to processor circuit 101. As described below in more detail, memory circuit 102 may buffer (or store) individual ones of instruction subset 105 prior to sending the instructions to processor circuit 101. In some cases, instruction data 108 (which includes instruction 104 and instruction subset 105) may be sent in a synchronous fashion using a clock signal (not shown in FIG. 1) as a timing reference.

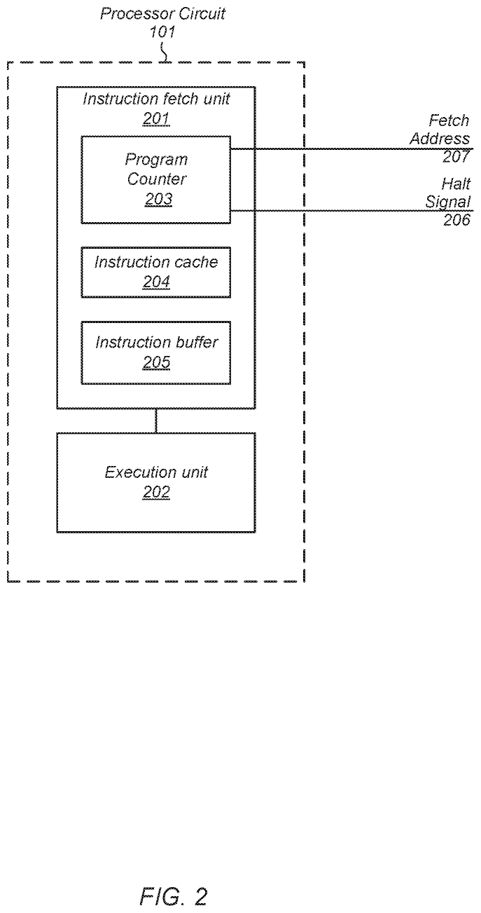

Processor circuits, such as those described above in regard to FIG. 1, may be designed according to various design styles based on performance goals, desired power consumption, and the like. An embodiment of processor circuit 101 illustrated in FIG. 2. As illustrated, processor circuit 101 includes instruction fetch unit 201 and execution unit 202. Instruction fetch unit 201 includes program counter 203, instruction cache 204, and instruction buffer 205.

Program counter 203 may be a particular embodiment of a state machine or sequential logic circuit configured to generate fetch address 207, which is used to retrieve program instructions from a memory circuit, such as memory circuit 102. To generate fetch address 207, program counter 203 may increment a count value during a given cycle of processor circuit 101. The count value may then be used to generate an updated value for fetch address 207, which can be sent to the memory circuit. It is noted that the count value may be directly used as the value for fetch address 207, or it may be used to generate a virtual version of fetch address 207. In such cases, the virtual version of fetch address 207 may be translated to a physical address before being sent to a memory circuit.

As described above, some instructions are calls to sequences of instructions compressed program code. When memory circuit 102 detects such an unconditional flow control instruction, memory circuit 102 will fetch the sequence of instructions starting from an address specified by unconditional flow control instruction. As particular instructions included in the sequence of instructions are being fetched, they are sent to processor circuit 101 for execution.

While memory circuit 102 is fetching the sequence of instructions, the last value of fetch address 207 may be saved in program counter 203, so that when execution of the received sequence of instructions has been completed, instruction fetching may be resume at the next address following the address that pointed to the unconditional flow control instruction. To maintain the last value of fetch address 207, program counter 203 may halt incrementing during each cycle of processor circuit 101 in response to an assertion of halt signal 206. As used herein, an assertion of a signal refers to changing a value of the signal to value (e.g., a logical-1 or high logic level, although active-low assertion may also be used) such that a circuit receiving the signal will perform a particular operation or task. For example, in the present embodiment, when halt signal 206 is asserted, program counter 203 stops incrementing and a current value of fetch address 207 remains constant, until halt signal 206 is de-asserted. Other techniques for managing program counter 203 to account for the expansion of compacted code by memory circuit 102 are also possible. For example, memory circuit 102 may supply program counter 203 with a particular number of instructions that are expected, which may be used to adjust the value of program counter 203.

Instruction cache 204 is configured to store frequently used instructions. In response to generating a new value for fetch address 207, instruction fetch unit 201 may check to see if that an instruction corresponding to the new value of fetch address 207 is stored in instruction cache 204. If instruction fetch unit 201 finds the instruction corresponding to the new value of fetch address 207 in instruction cache 204, the instruction may be stored in instruction buffer 205 prior to being dispatched to execution unit 202 for execution. If, however, the instruction corresponding to the new value of fetch address 207 is not present in instruction cache 204, the new value of fetch address 207 will be sent to memory circuit 102.

In various embodiments, instruction cache 204 may be a particular embodiment of a static random-access memory (SRAM) configured to store multiple cache lines. Data stored in a cache line may include an instruction along with a portion of an address associated with the instruction. Such portions of addresses are commonly referred to as “tags.” In some cases, instruction cache 204 may include comparison circuits configured to compare fetch address 207 to the tags included in the cache lines.

Instruction buffer 205 may, in some embodiments, be a particular embodiment of a SRAM configured to store multiple instructions prior to the instructions being dispatched to execution unit 202. In some cases, as new instructions are fetched by instruction fetch unit 201 and stored in instruction buffer 205, an order in which instructions are dispatched from instruction buffer 205 may be altered based on dependency between instructions stored in instruction buffer 205 and/or the availability of data upon which particular instructions stored in instruction buffer 205 are to operate.

Execution unit 202 may be configured to execute and provide results for certain types of instructions issued from instruction fetch unit 201. In one embodiment, execution unit 202 may be configured to execute certain integer-type instructions defined in the implemented instruction set architecture (ISA), such as arithmetic, logical, and shift instructions. While a single execution unit is depicted in processor circuit 101, in other embodiments, more than one execution unit may be employed. In such cases, each of the execution units may or may not be symmetric in functionality.

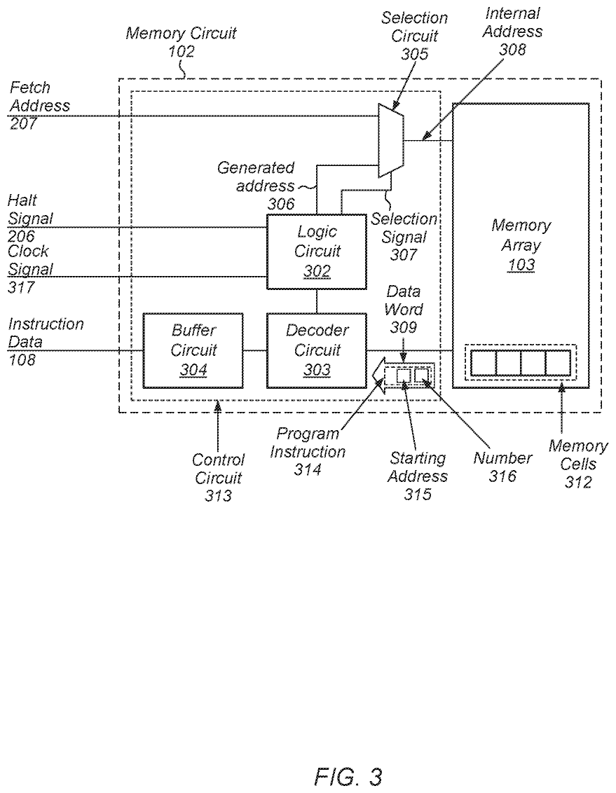

A block diagram depicting an embodiment of memory circuit 102 is illustrated in FIG. 3. As illustrated, memory circuit 102 includes memory array 103, and control circuit 313, which includes logic circuit 302, decoder circuit 303, buffer circuit 304, and selection circuit 305.

Memory array 103 includes memory cells 312. In various embodiments, memory cells 312 may be static memory cells, dynamic memory cells, non-volatile memory cells, or any type of memory cell capable of storing one or more data bits. Multiple ones of memory cells 312 may be used to store a program instruction, such as instruction 104. Using internal address 308, various ones of memory cells 312 may be used to retrieve data word 309, which program instruction 314. In various embodiments, program instruction 314 includes starting address 315, which specifies a location in memory array 103 of a sequence of program instructions. Program instruction 314 also includes number 316, which specifies a number of instructions included in the sequence of program instructions.

In various embodiments, memory cells 312 may be arranged in any suitable configuration. For example, memory cells 312 may be arranged as an array that includes multiple rows and columns. As described below in more detail, memory array 103 may include multiple banks or other suitable partitions. Decoder circuit 303 is configured to decode program instructions encoded in data words retrieved from memory array 103. For example, decoder circuit 303 is configured to decode program instruction 314 included in data word 309. In various embodiments, decoder circuit 303 may include any suitable combination of logic gates or other circuitry configured to decode at least some of the bits included in data word 309. Results from decoding data word 309 may be used by logic circuit 302 to determine a type of the program instruction 314. In addition to decoding data word 309, decoder circuit 303 also transfers data word 309 to buffer circuit 304 for storage.

Buffer circuit 304 is configured to store one or more data words that may encode respective program instructions stored in memory cells 312 included in memory array 103, and then send instruction data 108, which include fetched instructions fetched from memory array 103, to processor circuit 101. In some cases, multiple data words may be retrieved from memory array 103 during a given cycle of the processor circuit. For example, multiple data words may be retrieved from memory array 103 in response to a determination that a previously fetched instruction is a call type instruction. Since the processor circuit is designed to receive a single program instruction per cycle, when multiple data words are retrieved from memory array 103, they must be temporarily stored before being send to the processor circuit.

In various embodiments, buffer circuit 304 may be a particular embodiment of a first-in first-out (FIFO) buffer, static random-access memory, register file, or other suitable circuit. Buffer circuit 304 may include multiple memory cells, latch circuits, flip-flop circuits, or any other circuit suitable for storing a data bit.

Logic circuit 302 may be a particular embodiment of a state machine or other sequential logic circuit. Logic circuit 302 is configured to determine whether program instruction 314 included in data word 309 is a call type instruction using results of decoding the data word 309 provided by decoder circuit 303. In response to a determination that the program instruction 314 is a call type instruction, logic circuit 302 may perform various operations to retrieve one or more program instructions from memory array 103 referenced by the program instruction 314.

To fetch the one or more program instructions from memory array 103, logic circuit 302 may extract starting address 315 from program instruction 314. In various embodiments, logic circuit 302 may generate address 306 using starting address 315. In some cases, logic circuit 302 may generate multiple sequential values for generated address 306. The number of sequential values may be determined using number 316 included in program instruction 314. Additionally, logic circuit 302 may be configured to change a value of selection signal 307 so that selection circuit 305 generates internal address 308 by selecting generated address 306 instead of fetch address 207.

Additionally, logic circuit 302 may be configured to assert halt signal 206 in response to the determination that program instruction 314 is a call type instruction. As described above, when halt signal 206 is asserted, program counter 203 may stop incrementing until halt signal 206 is de-asserted. Logic circuit 302 may keep halt signal 206 asserted until the number of program instructions specified by number 316 included program instruction 314 have been retrieved from memory array 103 and stored in buffer circuit 304.

Selection circuit 305 is configured to generate internal address 308 by selecting either fetch address 207 or generated address 306. In various embodiments, the selection is based on a value of selection signal 307. It is noted that fetch address 207 may be received from a processor circuit (e.g., processor circuit 101) and may be generated by a program counter (e.g., program counter 203) or other suitable circuit. Selection circuit 305 may, in various embodiments, include any suitable combination of logic gates, wired-OR logic circuits, or any other circuit capable of selecting between fetch address 207 and generated address 306.

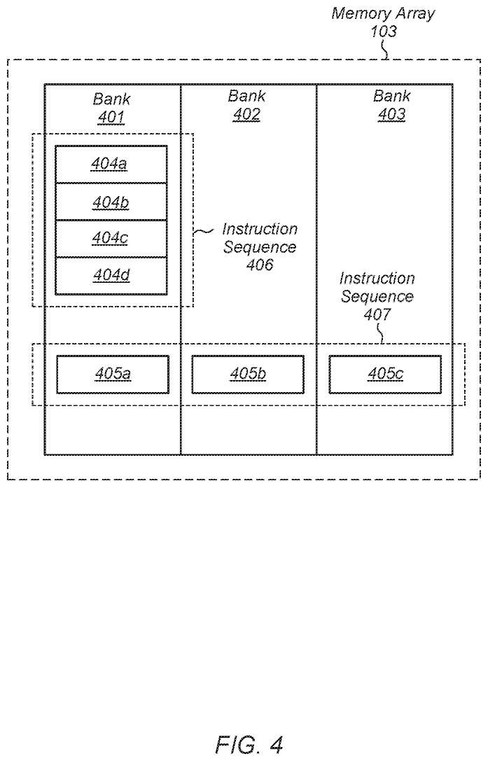

Memory arrays, such as memory array 103, may be constructed using various architectures. In some cases, multiple banks may be employed for the purposes of power management and to reduce load on some signals internal to the memory array. A block diagram depicting an embodiment of a multi-bank memory array is illustrated in FIG. 4. As illustrated, memory array 103 includes banks 401-403.

Each of banks 401-403 may include multiple memory cells configured to store instructions included in compacted program code, such as compacted program code 109. In various embodiments, a number of memory cells activated in parallel within a given one of banks 401-403 may correspond to a number of data bits included in a particular instruction included in the compacted program code.

In some cases, compacted program code may be stored in a sequential fashion starting with an initial address mapped to a particular location within a given one of memory banks 401-403. In other cases, however, pre-fetching of instructions included within a sequence of instructions referenced by an unconditional flow control instruction may be improved by storing different instructions of a given sequence of instructions across different ones of banks 401-403.

As illustrated, instruction sequences 406 and 407 are stored in memory array 103. In various embodiments, respective unconditional flow control instructions (not shown), that references instruction sequences 406 and 407, may be stored elsewhere within memory array 103. Instruction sequence 406 includes instructions 404a-404d, and instruction sequence 407 includes 405a-405c. Each of instructions 404a-404d are stored in memory cells included in bank 401, while each of instructions 405a-405c are stored in respective groups of memory cells in banks 401-403.

During retrieval of instruction sequence 406 in response to detection of an unconditional flow control instruction that references instruction sequence 406, bank 401 must be repeatedly activated to sequentially retrieve each of instructions 404a-404d. While this may still be an improvement in a time to pre-fetch instruction sequence 406 versus using a conventional program counter-based method, multiple cycles of the memory circuit 102 are still employed since only single rows within a given bank may be activated during a particular cycle of memory circuit 102.

In contrast, when an unconditional flow control instruction that references instruction sequence 407 is detected, each of instructions 405a-405c may be retrieved in parallel. Since banks 401-403 are configured to operate independently, more than one of banks 401-403 may be activated in parallel, allowing multiple data words, that correspond to respective instructions, to be retrieved from memory array 103 in parallel, thereby reducing the time to pre-fetch instructions 405a-405c. It is noted that activating multiple banks in parallel may result in memory circuit 102 dissipating additional power.

Structures such as those shown with reference to FIGS. 2-4 for accessing compacted program code may be referred to using functional language. In some embodiments, these structures may be described as including “a means for generating a fetch command,” “a means for storing a plurality of program instructions included in compacted program code,” “a means for retrieving a given program instruction of the plurality of program instructions,” “a means for determining a type of the given program instruction,” “a means for retrieving, in response to determining the given program instruction is a particular type of instruction, a subset of the plurality of program instructions beginning at an address included in the given program instruction,” and “a means for sending the subset of the plurality of program instructions to the processor circuit.”

The corresponding structure for “means for generating a fetch command” is program counter 203 as well as equivalents of this circuit. The corresponding structure for “means for storing a plurality of program instructions included in compacted program code” is banks 402-403 and their equivalents. Additionally, the corresponding structure for “means for retrieving a given program instruction of the plurality of program instruction” is logic circuit 302 and selection circuit 305, and their equivalents. The corresponding structure for “means for determining a type of the given program instruction” is decoder circuit 303 as well as equivalents of this circuit. The corresponding structure for “means for retrieving, in response to determining the given program instruction is a particular type of instruction, a subset of the plurality of program instructions beginning at an address included in the given program instruction” is logic circuit 302 and selection circuit 305, and their equivalents. Buffer circuit 304, and its equivalents are the corresponding structure for “means for sending the subset of the plurality of instructions to the processor circuit.”

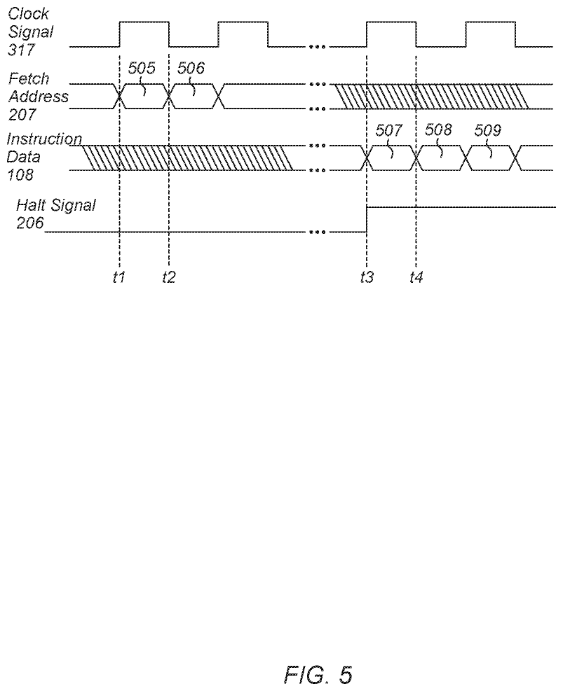

Turning to FIG. 5, example waveforms associated with fetching instructions are depicted. As illustrated, at time t1, clock signal 317 is asserted and fetch address 207 takes on value 505, while instruction data 108 is a logical “don't care” (i.e., its value can be either a logical-0 or a logical-1), and halt signal 206 is a logical-0. At time t2, value 505 of fetch address 207 is latched by memory circuit 102 and used to access memory array 103. Additionally, fetch address 207 transitions to value 506.

At time t3, clock signal 317 again transitions to a logical-1, and value 507 is output on instruction data 108 by memory circuit 102. In various embodiments, value 507 corresponds to an instruction specified by value 505 on fetch address 207, and the instruction is an unconditional flow control instruction. It is noted that the difference in time between time t2 and t3 may correspond to a latency of memory circuit 102 to retrieve a particular instruction from memory array 103.

In response to determining that the instruction specified by value 505 is an unconditional flow control instruction, memory circuit 102 asserts halt signal 206 at time t3. As described above, when halt signal 206 is asserted, program counter 203 is halted, and memory circuit 102 begins retrieving an instruction sequence specified by an address included in the instruction specified by value 505. At time t4, the first of the sequence of instructions, denoted by value 508, is output by memory circuit 102 onto instruction data 108. On the following falling edge of clock signal 317, the next instruction of the sequence of instructions (denoted by value 509) is output by memory circuit 102. Memory circuit 102 continues to output instructions included in the instruction sequence on both rising and falling edges of clock signal 317 until all of the instructions included in the sequence have been sent to processor circuit 101.

It is noted that waveforms depicted in FIG. 5 are merely examples. In other embodiments, fetch address 207 may transition only on rising edges of clock signal 317, and different relative timings between the various signals are possible.

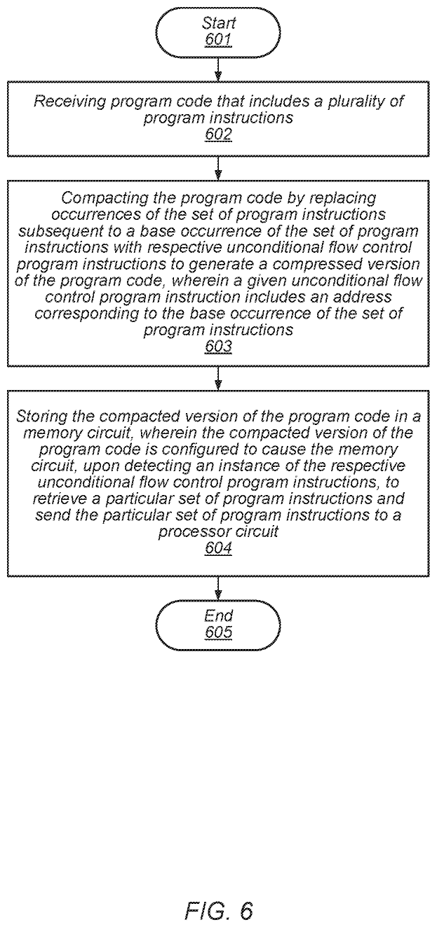

Turning to FIG. 6, a flow diagram depicting an embodiment of a method for fetching and decompressing program code is illustrated. The method, which may be applied to various computer systems, e.g., computer system 100 as depicted in FIG. 1, begins in block 601.

The method includes receiving program code that includes a plurality of program instructions (block 602). The received program code may be written in a low-level programming language (commonly referred to as “assembly language”) that highly correlates with instructions available in an ISA associated with the processor on which the code will be executed. Code written in an assembly language is often referred to as “assembly code.” In other cases, the received program code may be written in one of a variety of programming languages, e.g., C++, Java, and the like, and may include references to one or more software libraries which may be linked to the program code during compilation. In such cases, the program code may be translated into assembly language.

The method further includes compacting the program code by replacing occurrences of the set of program instructions subsequent to a base occurrence of the set of program instructions with respective unconditional flow control program instructions to generate a compacted version of the program code, wherein a given unconditional flow control program instruction includes an address corresponding to the base occurrence of the set of program instructions (block 603). In some cases, a processing script may be used to analyze the program code to identify multiple occurrences of overlapping code across different subroutines or macros as candidates for replacement with unconditional flow control program instructions. As described below in more detail, the method may include translating the program code into a different representation, e.g., a directed graph (or simply a “graph”) so that the relationships between the various individual program instructions across the different subroutines or macros can be identified.

The method also includes storing the compacted version of the program code in a memory circuit (block 604). In various embodiments, the compacted version of the program code is configured to cause the memory circuit, upon detecting an instance of the respective unconditional flow control program instructions, to retrieve a particular set of program instructions and send the particular set of program instructions to a processor circuit.

In some cases, the compacted version of the program code may be compiled prior to storing the in the memory circuit. As used herein, compiling program code refers to translating the program code from a programming language to collection of data bits, which correspond to instructions included in an ISA for a particular processor circuit. As described above, different portions of the program code may be stored in different blocks or partitions within the memory circuit to facilitate retrieval of instruction sequences associated with unconditional flow control instructions. The method concludes in block 607.

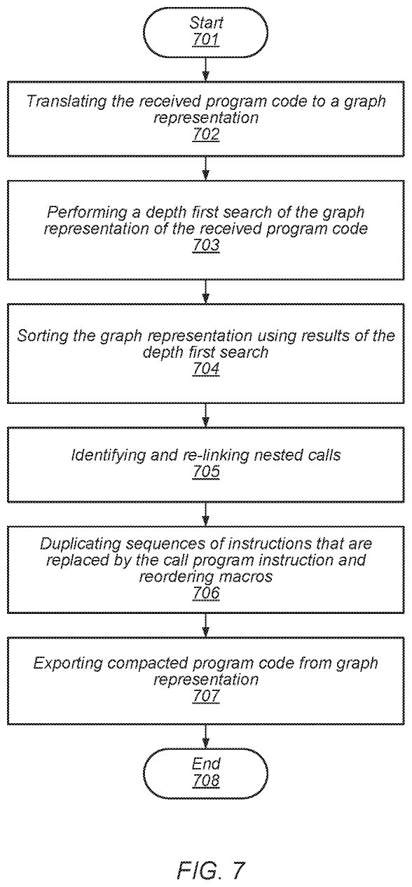

Turning to FIG. 7, a flow diagram depicting and embodiment of a method for compressing program code is illustrated. The method, which may correspond to block 603 of the flow diagram of FIG. 6, begins in block 701.

The method includes translating the received program code to a graph representation (block 702). As part of translating the received program code to the graph representation, some embodiments of the method include arranging subroutines or macros included in the received program code on the basis of the number of instructions included in each subroutine or macro. Once the subroutines or macros have been arranged, the method may continue with assigning, by the processing script, a name of each subroutine or macro to a respective node within the graph representation. In some embodiments, the method further includes assigning, for a given subroutine or macro, individual program instructions included in the given subroutine or macro to child nodes of the particular node to which the given subroutine name is assigned. The process may be repeated for all subroutines or macros included in the received program code.

The method also includes performing a depth first search of the graph representation of the received program code using the graph representation (block 703). In various embodiments, the method may include starting the search from a node in the graph representation corresponding to a particular subroutine or macro that has a smallest number of child nodes. Using the node as the smallest number of child nodes as a starting point, the individual program instructions included in particular subroutine or macro are compared to the program instructions included in other subroutines or macros included in the received assembly code. Program instructions that are common (or “overlapping”) between one subroutine or macro and another subroutine or macro are identified.

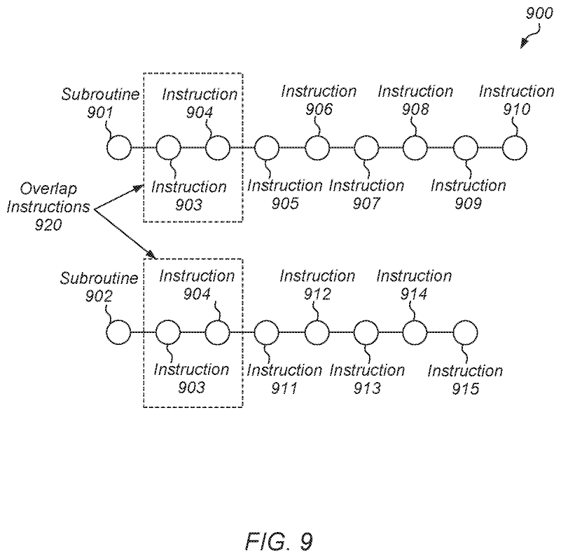

An example of a graph representation of program code that includes overlapping instructions is depicted in FIG. 9. As illustrated, program code 900 includes subroutines 901 and 902. Subroutine 901 includes program instructions 903-910, and subroutine 902 also includes instances of program instructions 903 and 904, as well as program instructions 911-915. Since instances of program instructions 903 and 904 are included in both subroutine 901 and 902, both instances of program instructions 903 and 904 are identified as overlap instructions 920. Although only a single case of overlapping program instructions is depicted in the embodiment illustrated in FIG. 9, in other embodiments, multiple sequences of program instructions may overlap between two or more subroutines or macros.

The method further includes sorting the graph representation of the received program code using results of the depth first search (block 704). To improve the efficiency of the compaction of the received program code, certain sequences of program instructions within a given subroutine or macro may be reordered so that the reordered sequence of program instructions is the same as a sequence of program instructions in another subroutine or macro, thereby increasing an amount of overlapped code between the two subroutines or macros. It is noted that care must be taken in rearranging the order of the program instructions so as to not affect the functionality of a given subroutine or macro. In various embodiments, a bubble sort or other suitable sorting algorithm may be used to sort program instructions within a subroutine or macro on the basis of the number of times each program instruction is used with the subroutine or macro without affecting the functionality of the subroutine or macro.

The method also includes identifying and re-linking nested calls (block 705). In some cases, a given subroutine or macro may include a sequence of program instructions which overlap with multiple other subroutines or macros. The graph representation may indicate that the overlapping between the various subroutines or macros as being nested. As used herein, a nested overlap refers to a situation where a first subroutine or macro has a sequence of program instructions that overlap with a second subroutine or macro, which, in turn, overlaps with a third subroutine or macro.

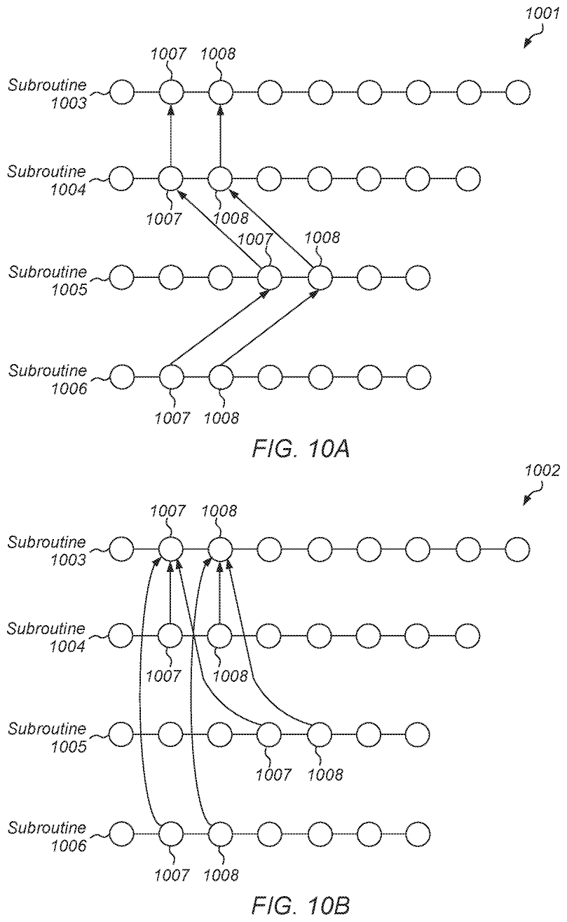

An example of nested links is illustrated in FIG. 10A. Program instructions 1007 and 1008 are included in each of subroutines 1003-1006. As sorted and identified by the previous operations, the instances of program instructions 1007 and 1008 in subroutine 1006 are linked to the instances of program instructions 1007 and 1008 included in subroutine 1005. In a similar fashion, the instances of program instructions 1007 and 1008 included in subroutine 1005 are linked to the instances of program instructions in 1007 and 1008 included in subroutine 1004, which are, in turn, linked to the instances of program instructions 1007 and 1008 in subroutine 1004.

To further improve the efficiency of the compaction, nested overlaps are re-linked within the graph such that all subsequent occurrences of a particular sequence of program instructions directly link to the initial occurrence of the particular sequence of program instructions. An example of re-linking sequences of program instructions is depicted in FIG. 10B. As illustrated, the instances of program instructions 1007 and 1008 in each of subroutines 1004, 1005, and 1006 are now linked directly the initial instances of program instructions 1007 and 1008 included in subroutine 1003.

The method further includes duplicating sequences of program instructions replaced by respective unconditional flow control program instructions (block 706). In various embodiments, a particular unconditional flow control program instruction will include an address corresponding to the location of the initial occurrence of the sequence of program instructions that the particular is replacing. Additionally, the particular unconditional flow control program instruction may include a number of instructions that are included in the sequence of program instructions the particular program instruction is replacing.

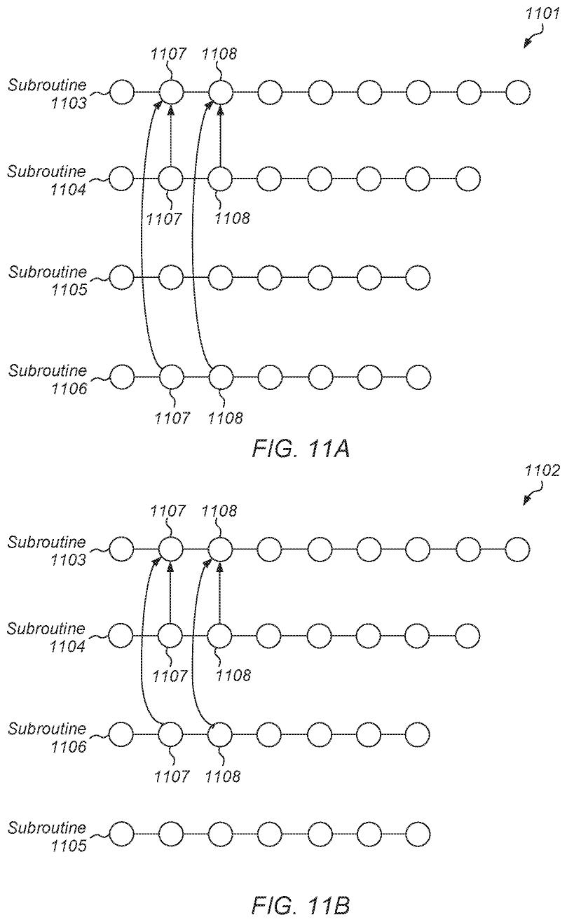

In some cases, the method may include re-ordering the subroutines or macros within the compressed program code. When an unconditional flow control program instruction is inserted to replace a duplicate sequence of program instructions, a change in address value from the unconditional flow control instruction will result. The larger the change in address value, the larger the number of data bits necessary to encode the new address value. An example of an initial order of program instructions is depicted in FIG. 11A. As illustrated in program code 1101, both subroutines 1104 and 1106 include instances of program instructions 1107 and 1108, which are mapped to initial instances of program instructions 1107 and 1108 included in subroutine 1103. An unconditional flow control instruction inserted to replace the instances of program instructions 1107 and 1108 in subroutine 1106 will result in a larger change in address value than the insertion of an unconditional flow control instruction to replace the instances of program instructions 1107 and 1108 included in subroutine 1104.

To minimize this change in address value, the subroutines or macros within the compressed program code may be reordered so that subroutines or macros with a large amount of overlapping program instructions may be located near each other in the address space of the compressed program code. An example of reordered subroutines is depicted in FIG. 11B. As illustrated, the positions of subroutine 1105 and subroutine 1006 within program code 1102 have been interchanged. By changing the order of subroutines 1105 and 1106, the change in address value resulting from the insertion of an unconditional flow control instruction to replace in the instances of program instructions 1107 and 1108 in subroutine 1106 will be reduced.

The method also includes exporting compacted program code from the graph representation (block 707). In various embodiments, the processor script may generate a file that includes the compacted program code by incorporating all of the changes made to the initial program code using the graph representation. The compacted code may be stored directly in a memory circuit for use by a processor circuit or may be further processed or compiled before being stored in the memory circuit. The method concludes in block 708.

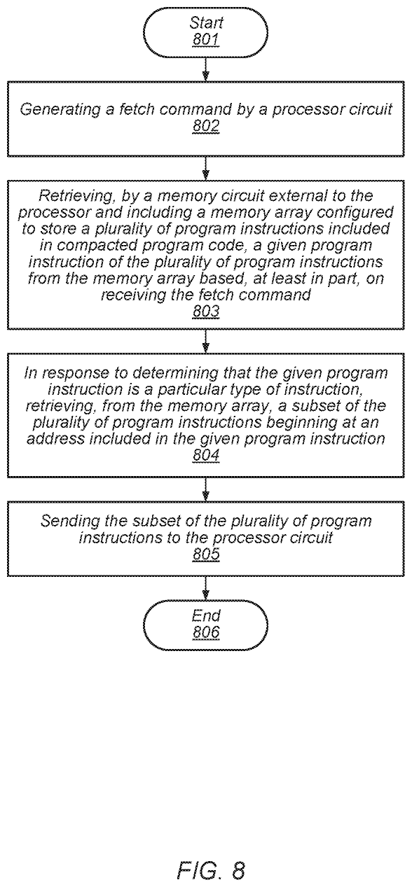

Turning to FIG. 8, a flow diagram depicting an embodiment of a method for operating a processor circuit and a memory circuit in a computer system is illustrated. The method, which may be applied to various embodiments of computer system including the embodiment depicted in FIG. 1, begins in block 801.

The method includes generating a fetch command by a processor circuit (block 802). In various embodiments, the method may include incrementing a program counter count value and generating an address using the program counter count value, and including the address in the fetch command.

The method further includes retrieving, by a memory circuit external to the processor and including a memory array configured to store a plurality of program instructions included in compacted program code, a given program instruction of the plurality of instructions from the memory array based, at least in part, on receiving the fetch command (block 803). In some embodiments, the method may include extracting address information from the fetch command, and activating particular ones of multiple memory cells included in the memory array using the extracted address information.

In response to determining that the given program instruction is a particular type of instruction, the method also includes retrieving, from the memory array, a subset of the plurality of program instructions beginning at an address included in the given program instruction (block 804). It is noted that, in various embodiments, the type of instruction may include an unconditional flow control instruction, which may change the flow of the program code to a particular instance of a sequence of instructions included in the subset of the plurality of program instructions.

The method also includes sending the subset of the plurality of program instructions to the processor circuit (block 805). In various embodiments, the method may include buffering (or storing) individual ones of the subset of program instructions. The method may also include sending the subset of the plurality of program instructions to the processor circuit in a synchronous fashion using a clock signal as a timing reference. The method concludes in block 806.

As described above, by employing memory circuit 102 in conjunction with compressed program code, portions of the program code at the function level may be reused, thereby improving performance. While such a solution provides reuse of function calls, there is no reuse within a particular function or subroutine. In some cases, conditional branch instructions within a function can consume large numbers of processing cycles. When this occurs, overall performance may drop and certain applications, e.g., real time processing of data, may fail or produce undesirable results. For example, real time applications may expect to process data according to a time constraint, but variability in execution time produced by conditional branch instructions may make it difficult to ensure that the time constraint is satisfied, potentially yielding incorrect or unpredictable results. In some cases, execution of the program code may affect the generation and duration of control signals used to control devices (e.g., programming or erasing non-volatile memory cells). The use of such control signals may be subject to scheduling constraints that, if violated, could cause physical damage to the controlled devices. For example the large number of programming cycles associated with conditional branch instructions may result the control signals being active for too long, thereby decreasing the life of the devices.

An example of a function, which includes conditional branch instructions, is depicted in CODE EXAMPLE 1. As illustrated, gcd compares two numbers, a and b, and returns the maximum of the two numbers. An assembly code version of gcd is depicted in CODE EXAMPLE 2.

CODE EXAMPLE 1: gcd program code

int gcd (int a, int b)
{
while (a!=b)
{

if(a<b)

a = a−b;

else

b = b−a;

}
return a;

}

CODE EXAMPLE 2: gcd assembly code

gcd

CMP r0, r1
BEQ end
BLT less
SUB r0, r0, r1
Jump gcd

less

SUB r1, r1, r0
Jump gcd

End

Each of instructions BLT less, Jump gcd, and BEQ end may use more compute cycles than the other commands within the gcd function. For example, in some cases, CMP r0, r1 consumes a single cycle, while BLT less consumes five cycles when the branch is not taken. An example of the execution of the gcd command with a=1 and b=2 is illustrated in TABLE 1. In this case, when the branch associated with the BLT less is not taken, a five cycle penalty is incurred. A similar situation arises when BEQ end is not take and when Jump gcd is executed.

The embodiments described below may provide techniques for modifying program code by identifying program loops and replacing certain program instructions included in the program loop, as well as inserting information within the program code that identifies the beginning of a program loop, thereby allowing reuse code associated with conditional branches within a function to reduce a number of execution cycles, thereby improving performance.

TABLE 1
Execution of gcd command with a = 1, b = 2

| r0(a) | r1(b) | Instruction | Cycles |
|---|---|---|---|
| 1 | 2 | CMP r0, r1 | 1 |
| 1 | 2 | BEQ end | 1 (not executed) |
| 1 | 2 | BLT less | 5 |
| 1 | 2 | SUB r1, r1, r0 | 1 |
| 1 | 2 | Jump gcd | 5 |
| 1 | 1 | CMP r0, r1 | 1 |
| 1 | 1 | BEQ end | 5 |
| 1 | | | Total = 19 |

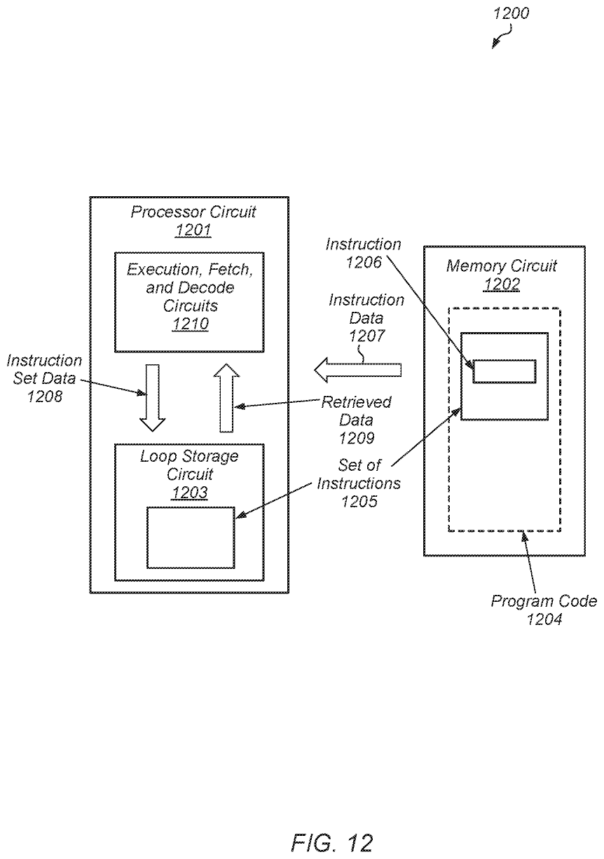

A block diagram illustrating an embodiment of a computer system is depicted in FIG. 12. As illustrated, computer system 1200 includes processor circuit 1201, memory circuit 1202, and loop storage circuit 1203. In various embodiments, either one or both of memory circuit 1202 and loop storage circuit 1203 are external to processor circuit 1201.

Memory circuit 1202 may, in various embodiments, be an embodiment of a static random-access memory circuit, or other suitable circuit configured to store program code 1204. In some embodiments, memory circuit 1202 may correspond to memory circuit 102 as illustrated in FIG. 1. As described below in more detail, program code 1204 may include a plurality of program instructions (also referred to as simply “instructions”), including instruction 1206, which is included in set of instructions 1205. Such instructions when received and executed by processor 1201, may result in processor circuit 1201 performing a variety of operations including accesses to loop storage circuit 1203. It is noted that program code 1204 may be compacted in a fashion similar to program code 109 as illustrated in FIG. 1.

Processor circuit 1201 may be a particular embodiment of a general-purpose processor configured to fetch instruction 1206 from memory circuit 1202. In various embodiments, processor circuit 1201 may include the features of processor circuit 101 as depicted in FIG. 1. As described below in more detail, to fetch instruction 1206, processor circuit 1201 may be further configured to generate a fetch command that includes an address corresponding to a storage location of instruction 1206 in memory circuit 1202.

In response to a determination that the instruction 1206 is a loop boundary instruction, processor circuit 1201 is further configured to store set of instructions 1205 (denoted at instruction set data 1208) in loop storage circuit 1203. In various embodiments, set of instructions 1205 is included in a first program loop associated with instructions 1206. By storing set of instructions 1205 in loop storage circuit 1203, subsequent iterations of the first program loop may use the copy of set of instructions 1205 in loop storage circuit 1203, thereby reducing access time to the instructions and improving performance. In some cases, processor circuit 1201 may be further configured to decode instructions included in set of instructions 1205 and store decoded versions of the instructions included in set of instructions 1205 in loop storage circuit 1203.

In some circumstances, an instruction loop may contain more instructions than can be stored within loop storage circuit 1203. In some embodiments, when it is determined that set of instructions 1205 exceeds available storage in loop storage circuit 1203, processor 1201 may halt storing remaining instructions of set of instructions 1205 in loop storage circuit 1203. Additionally, processor circuit 1201 may reset a valid bit associated loop storage circuit 1203, or clear the contents of loop storage circuit 1203, and execution remaining iterations of the first program loop by retrieving instructions from memory circuit 1202.

As used and described herein, a loop boundary instruction is an instruction that identifies a start of a program loop. In some embodiments, certain types of instructions (e.g., compare instructions and/or other instructions that modify condition codes or flags within processor circuit 1201) may be defined to be loop boundary instructions, such that whether a given instruction is a loop boundary instruction may be determined by decoding the opcode of the given instruction. As described below in more detail, in other embodiments, one or more bits included in a particular field in the loop boundary instruction may identify a loop boundary instruction, which may facilitate identifying a loop boundary instruction without fully decoding the instruction. Such bits may be added or changed by a processing script, e.g., processing script 2005. Alternatively, the processing script may add a no operation (or “no op”) loop boundary instruction into the program code that identifies the start of a program loop but does not otherwise perform an operation.

Whereas a loop boundary instruction identifies the start of a program loop, in some embodiments the end of the program loop is defined by a branch instruction that depends (directly or indirectly) on the loop boundary instruction, such as a conditional branch instruction. In such embodiments, loop boundary instructions are not themselves branch instructions, but are instead other instructions that work in combination with branch instructions to define the structure of the loop. For example, embodiments of loop boundary instructions include instructions that modify processor state (e.g., flags/condition codes and the like) in a manner that is detectable by a branch instruction.

Processor circuit 1201 is also configured to execute at least one iteration of the first program loop subsequent to an execution of an initial iteration of the first program loop. In some embodiments, to execute the at least one iteration, processor circuit 1201 is further configured to retrieve set of instructions 1205 (denoted as retrieved data 1209) from loop storage circuit 1203. In various embodiments, the retrieval of set of instructions 1205 from loop storage circuit 1203 may be performed by circuits included in execution, fetch, and decode circuits 1210. When executing loop iterations, retrieving the instructions from loop storage circuit 1203 may improve performance relative to retrieving the instructions from memory circuit 1202.

In some embodiments, processor circuit 1201 may be configured, in response to an execution of a final iteration of the first program loop, clear set of instructions 1205 from loop storage circuit 1203, and fetch a next instruction from memory circuit 1202. As noted above, a branch instruction may be used to indicate the end of the first program loop. When a condition associated with the branch instruction indicates the branch is taken, the first program loop may execute again. Alternatively, when the condition associated with the branch instruction indicates the branch is not taken, the first program loop may end. Upon detection of the final iteration of the first program loop (e.g., based on taken/not taken status of the branch instruction terminating the loop), processor circuit 1201 may clear a valid bit in loop storage circuit 1203, thereby causing execution, fetch, and decode circuits 1210 to fetch a next instruction from memory circuit 1202. Alternatively, or additionally, execution, fetch, and decode circuit 1210 may include a status bit or other state that indicates whether fetching should be performed from memory circuit 1202 or loop storage circuit 1203; this state may be activated upon detection of a loop boundary instruction and deactivated upon detection of a final iteration of a loop.

In some cases, one program loop may be nested within another program loop. Such a situation may be identified when one of set of instructions 1205 is a loop boundary instruction. Processor circuit 1201 may handle such nesting of program loops in a variety of fashions. In some cases, processor circuit 1201 may be configured to fetch a second set of program instructions from memory circuit 1202, but not store them in loop storage circuit 1203.

Alternatively, processor circuit 1201 may be further configured, in response to a determination that a different instruction included in set of instructions 1205 is a loop boundary instruction, to fetch a second set of instructions included in a second program loop from memory circuit 1202. Processor circuit 1201 may also be configured to retrieve the second set of program instructions from loop storage circuit 1203, and execute at least one iteration of the second program loop subsequent to an execution of an initial iteration of the second program loop using the second set of program instructions retrieved from loop storage circuit 1203. It is noted that in cases where the total number of instructions included in the first and second set of instructions exceeds the storage space of loop storage circuit 1203, in some embodiments, processor circuit 1202 may be configured to store the first set of instructions in loop storage circuit 1203 and execute the second set of instructions from memory circuit 1202.

As described below in more detail, in some embodiments, loop storage circuit 1203 may include multiple banks. In such cases, in response to the determination that the different instruction included in the set of instructions 1205 is a loop boundary instruction, processor 1201 may be configured to store set of instructions 1205 in a first bank of loop storage circuit 1203 and the second set of instructions in a second bank of loop storage circuit 1203.

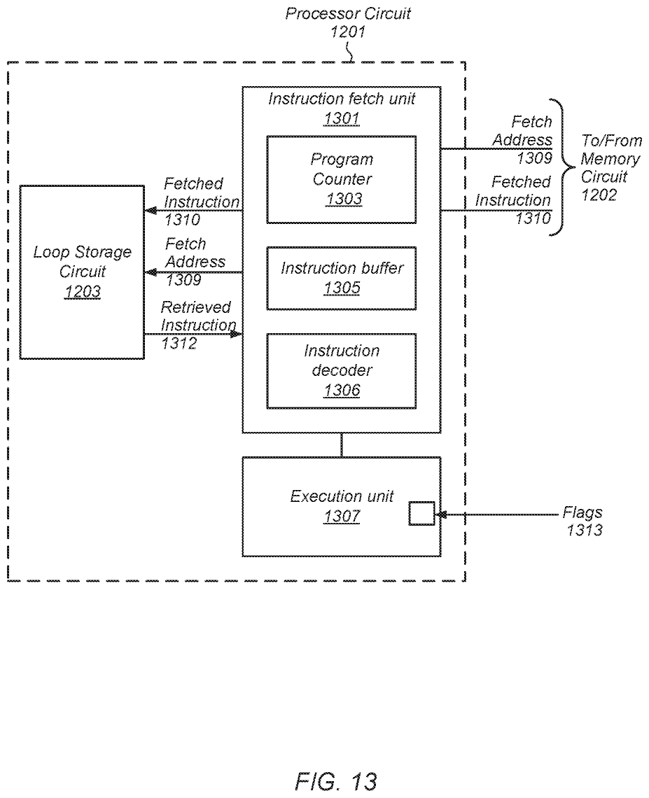

As noted above, processor circuits, e.g., processor circuit 1201, may be designed according to various design styles. An embodiment of processor circuit 1201 is depicted in FIG. 13. As illustrated, processor circuit 1201 includes instruction fetch unit 1301, execution unit 1307, and loop storage circuit 1203. Instruction fetch unit 1301 includes program counter 1303, instruction buffer 1305, and instruction decoder 1306. It is noted that in various embodiments, processor circuit 1201 may be configured to perform operations, tasks, and the like, in a similar fashion to processor circuit 101 as depicted in FIG. 1.

Program counter 1303 may be a particular embodiment of a state machine or sequential logic circuit configured to generate fetch address 1309, which is used to retrieve program instructions from memory circuit 1202. To generate fetch address 1309, program counter 1303 may increment a count value during a given cycle of processor circuit 1201. The count value may then be used to generate an updated value for fetch address 1309, which can be sent to memory circuit 1202. It is noted that the count value may be directly used as the value for fetch address 1309, or it may be used to generate a virtual version of fetch address 1309. In such cases, the virtual version of fetch address 1309 may be translated to a physical address before being sent to memory circuit 1202.

When a loop boundary instruction is detected, fetch address 1309 may be sent to loop storage circuit 1203 to be stored along with an instruction stored in memory circuit 1202 at a location indicated by fetch address 1309. The storage may be repeated until all of the instructions included in a program loop identified by the loop boundary instruction are stored in loop storage circuit 1203. Once the last instruction of the program loop has been stored in loop storage circuit 1203, a status bit or other identifying information in execution, fetch, and decode circuits 1210 may be set to indicate subsequent requests for instructions in the program loop are to be fetched from loop storage circuit 1203, as mentioned above. Upon termination of the program loop, or other fault situation, e.g., overflow of loop storage circuit 1203, the status bit or other identifying information may be reset to allow instructions to be fetched from memory circuit 1202.

After an execution of an initial iteration of the program loop, program counter 1303 may regenerate addresses for instructions included in the program loop. Since the status bit or other identifying information has been set, the regenerated addresses are sent to loop storage circuit 1203. In some cases, the regenerated addresses are not sent to memory circuit 1202. Loop storage circuit 1203 may use the regenerated addresses to retrieve the previously stored instructions and send them back to instruction fetch unit 1301.

Instruction buffer 1305 may, in some embodiments, be a particular embodiment of a SRAM configured to store multiple instructions prior to the instructions being dispatched to execution unit 1307. In some cases, new instructions that are fetched by instruction fetch unit 1301 are stored in instruction buffer 1305. In response to a detection of a loop boundary instruction, instructions included in a program loop identified by the loop boundary instruction may be moved from instruction buffer 1305 to loop storage circuit 1203.

Instruction decoder 1306 is configured to decode a subset of bits included in a given instruction retrieved from instruction buffer 1305. By decoding the subset of the bits included in the given instruction, instruction decoder 1306 may identify particular types of instructions, e.g., loop boundary instruction. The decoded instruction, along with other information, e.g., an indication of a loop boundary instruction, is sent to execution unit 1307 for execution.

When a loop boundary instruction is detected, instruction decoder 1306 may be configured to send fetched instruction 1310 to loop storage circuit 1203, which may store fetched instruction 1310 along with fetch address 1309 at a particular storage location within loop storage circuit 1203. It is noted that fetched instruction 1310 may be stored in loop storage circuit 1203 in a format in which it was received from memory circuit 1202. Alternatively, a decoded version of fetched instruction 1310 may be stored in loop storage circuit 1203. By storing decoded versions of the instructions in a program loop, further performance improvement in the execution of the program loop may be obtained. After an execution of an initial iteration of a program loop corresponding to the loop boundary instruction, the previously stored instructions in loop storage circuit 1203 are retrieved and stored in instruction buffer 1305 to be scheduled for execution by execution unit 1307. During execution of iterations subsequent to the initial iteration of the program loop, instruction decoder 1306 may be bypassed as the instructions retrieved from the loop storage circuit have been previously decoded.

Execution unit 1307 may be configured to execute and provide results for certain types of instructions issued from instruction fetch unit 1301. In one embodiment, execution unit 1307 may be configured to execute certain integer-type instructions defined in the implemented instruction set architecture (ISA), such as arithmetic, logical, and shift instructions. While a single execution unit is depicted in processor circuit 1201, in other embodiments, more than one execution unit may be employed. In such cases, each of the execution units may or may not be symmetric in functionality.

In some cases, when execution unit 1307 receives an instruction with conditional execution, execution unit 1307 may test a condition specified by the instruction with flags 1313. When the condition specified by the instruction is met, execution unit 1307 will execute the instruction, otherwise the instruction will be treated as a no-op. In various embodiments, flags 1313 may include multiple latch or flip-flop circuits that maintain a current state, i.e., values of registers, control bits, and the like, of execution unit 1307.

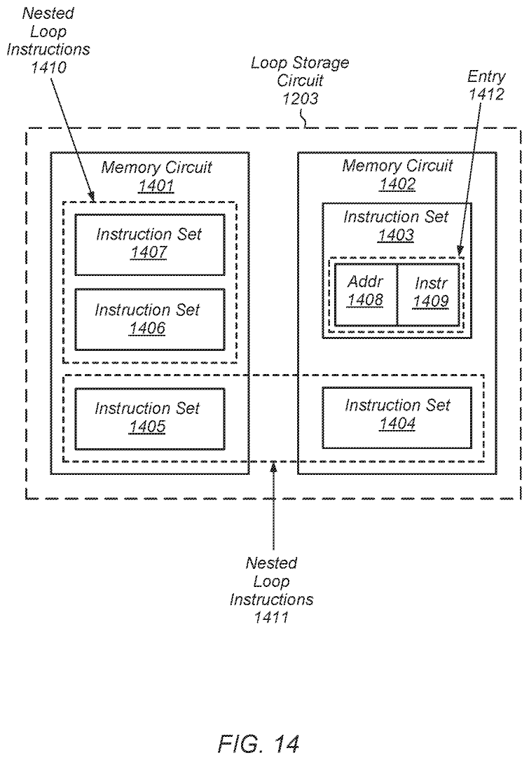

A block diagram of an embodiment of loop storage circuit 1203 is depicted in FIG. 14. As illustrated, loop storage circuit 1203 includes memory circuits 1401 and 1402. Although only two memory circuits are depicted in the embodiment of FIG. 14, in other embodiments, any suitable number of memory circuits may be employed.

Memory circuits 1401 and 1402 may be particular embodiments of content-addressable memories (commonly referred to as “CAMs”) configured to store one or more instruction sets. For example, instructions sets 1405-1407 are stored in memory circuit 1401 and instructions sets 1403 and 1404 are stored in memory circuit 1402. As described above, instruction sets 1403-1407 may include multiple program instructions. The program instructions included in a particular instruction set may be included in a corresponding program loop.

As noted above, memory circuits 1401 and 1402 may be content-addressable memories. In such cases, a particular entry in either of memory circuit 1401 or 1402 may include both an address and an instruction stored in either its native format or a decoded format. For example, entry 1412 in memory circuit 1402 includes an address (denoted “addr 1408”) and a decoded instruction (denoted as “instr 1409”). In various embodiments, decoded instructions, e.g., instr 1409, may be retrieved from either of memory circuit 1401 or 1402 using an address associated with the desired instruction. Comparison circuits (not shown) may compare a received address with the addresses in the various entries of either memory circuit 1401 or 1402, and return a decoded address value corresponding to the received address.

As described above, program code may include nested program loops. In such cases, instruction sets associated with the nested loops may be stored in different fashions within loop storage circuit 1203. In some cases, instruction sets associated with respective program loops in a group of nested loops may be stored in the same memory circuit. For example, instructions sets 1406 and 1407, which are included in nested loop instructions 1410, are both stored in memory circuit 1401. In some cases, different instruction sets are stored in different ranges of addresses within a memory circuit. In other cases, instructions included in the different instruction sets may be share a common range of addresses within a memory circuit.

In some embodiments, different memory circuits may be used to store different instructions sets associated with the respective program loops. For example, instruction sets 1404 and 1405 are included in nested loop instructions 1411, with instruction set 1404 stored in memory circuit 1402 and instruction set 1405 stored in memory circuit 1401. Although nested loop instructions 1410 and 1411 are depicted as including only two instructions sets and, therefore, only including two program loops, in other embodiments, any suitable number of program loops can be nested and stored in loop storage circuit 1203 using either of the above-referenced techniques.

Structures such as those shown with reference to FIGS. 12-14 for accessing and executing modified program code may be referred to using functional language. In some embodiments, these structures may be described as including “a means for storing a plurality of program instructions included in program code,” “a means for fetching a particular program instruction of the plurality of program instructions,” “a means for, in response to a determination that the particular program instruction is a loop boundary instruction, storing a first set of program instructions in a first loop storage circuit, wherein the first set of program instructions are included in a first program loop associated with the particular program instruction,” “a means for executing at least one iteration of the first program loop subsequent to an execution of an initial iteration of the first program loop,” and “a means for retrieving the first set of program instructions from the first loop storage circuit.”

The corresponding structure for “means for storing a plurality of program instructions included in program code” is memory circuit 1202 and its equivalents. The corresponding structure for “means for fetching a particular program instruction of the plurality of program instructions” is instruction fetch unit 1301 and its equivalents. The corresponding structure for “a means for, in response to a determination that the particular program instruction is a loop boundary instruction, storing a first set of program instructions in a first loop storage circuit, wherein the first set of program instructions are included in a first program loop associated with the particular program instruction” is execution unit 1301, instructions fetch unit 1301, loop storage circuit 1203, and their equivalents. The corresponding structure for “means for executing at least one iteration of the first program loop subsequent to an execution of an initial iteration of the first program loop” is execution unit 1307. Instruction fetch unit 1301 and its equivalents are the corresponding structure for “means for retrieving the first set of program instructions from the first loop storage circuit.”

Functions or subroutines may include program loops, which use conditional branch instructions to control program flow within a particular function or subroutine. The use of such conditional branch instructions may increase a number of cycles to execute a given program loop. As noted above, by modifying program code and employing a loop storage circuit, the cycle penalty associated with the use of conditional branch circuits may be reduced.

The modifications to the program code may include two types of modifications. The first of these types of modifications involves modifying particular logical or arithmetic operations to operate in a conditional fashion. For example, the combination of the BLT less and SUB r1, r1, r0 commands in CODE EXAMPLE 2 may be replaced with a single command, i.e., SUBLE r1, r1, r0, which is executed conditionally executed. Upon encountering such a modified instruction, execution unit 1307 may test the condition specified by the modified command, e.g., less than, against current values of flags 1313. Based on results of the test, execution unit will either execute the modified instruction or treat the modified instruction as a no-op. In various embodiments, the use of such modifications may eliminate the need for branching within a function or subroutine.

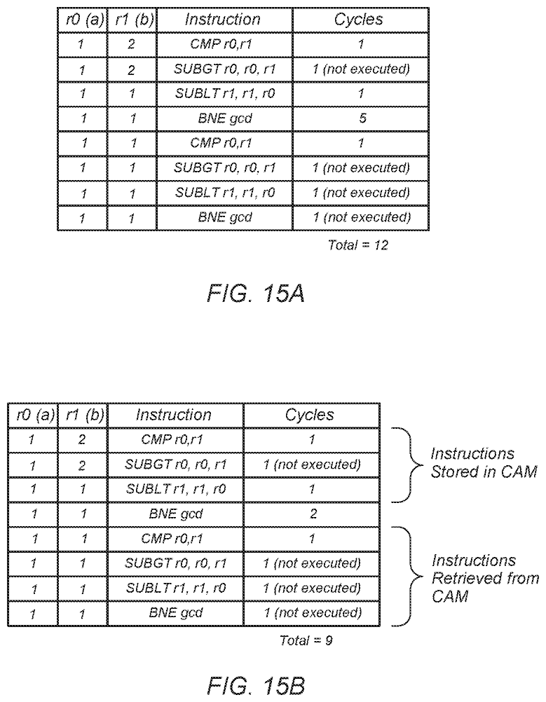

An example of execution of modified gcd assembly code for a=1 and b=2 is depicted in FIG. 15A. As illustrated, the table of FIG. 15A depicts the values registers r0 and r1, along with the instructions being executed and the number of cycles used to execute each instruction. Compared to the execution example of TABLE 1, the use of SUBGT r0, r0, r1 and SUBLT r1, r1, r0 reduce the total number of cycles needed to compete the function call to 12 cycles, compared to the 19 cycles needed when executing the unmodified code.

Most of the instructions depicted in the table of FIG. 15A are executed in a single cycle. The instruction BNE gcd, however, consumes five cycles when then branch is not taken. The additional cycles may result from having to re-fetch the CMP r0, r1 command from memory circuit 1202. As described above, to reduce the cycle penalty associated with this type of branch, the code for the program loop may be stored in loop storage circuit 1203. When BNE gcd is not taken, the next instruction, CMP r0, r1, is retrieved from loop storage circuit 1203 instead of memory circuit 1202, reducing the cycle overhead to get CMP r0, r1 to execution unit 1307.

An example of execution of modified gcd assembly code for a=1 and b=2 using a loop storage circuit is depicted in FIG. 15B. As illustrated, the table of FIG. 15B depicts the values of register r0 and r1, along with the instructions being executed and the number of cycles used to execute each instruction. During a base iteration of the gcd function, instructions CMP r0, r1, SUBGTrO, r0, r1, and SUBLT r1, r1, r0 are stored in loop storage circuit 1203. During the next iteration (after BNE gcd is evaluated), instructions CMP r0, r1, SUBGT r0, r0, r1, and SUBLT r1, r1, r0 are retrieved from loop storage circuit 1203 for execution. In this case, when the branch associated with the BNE gcd command is not taken, the cycle penalty is only two cycles, reducing the overall number of cycles to execute the gcd function to 9 cycles. Reducing the number of cycles in this fashion can improve overall system performance, as well as reduce power consumption.

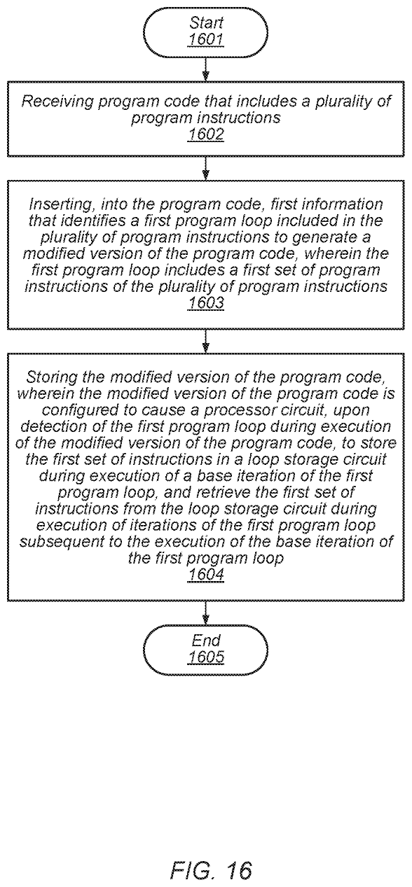

Turning to FIG. 16, a flow diagram depicting an embodiment of a method for modifying program code is illustrated. The method, which may be applied to various computer systems, e.g., computer system 1200 as depicted in FIG. 1, begins in block 1601.

The method includes receiving program code that includes a plurality of program instructions (block 1602). In various embodiments, the program code may correspond to the program code describe in regard to FIG. 7. The program code may, in some embodiments, include multiple program loops and function calls. In some cases, a particular program loop may include one or more nested program loops.

The method also includes inserting, into the program code, first information that identifies a first program loop included in the program instructions to generate a modified version of the program code, wherein the first program loop includes a first set of program instructions of the plurality of program instructions (block 1603). In some embodiments, inserting the first information that identifies the first program loop may include inserting an identification instruction into the plurality of program instructions. Alternatively, in other embodiments, inserting the first information that identifies the first program loop may include modifying a particular instruction of the plurality of instructions to identify the particular instruction as a first instruction of the first program loop. In some cases, the particular instruction may include a loop boundary instruction, which begins the first program loop.

In other embodiments, the method may include replacing a combination of a conditional branch instruction and an operation instruction with a conditional execution instruction. As used herein, an operation instruction is a program instruction that specifies a particular arithmetic, logical, or other suitable operation be performed by a processor circuit, and a conditional execution instruction is an instruction that is executed when a specified condition is met. In some cases, executing a conditional execution instruction includes testing the specified condition using one or more flags associated with the processor circuit.

The method may also include inserting into the program code, second information that identifies an end to the first program loop. In such cases, the modified version of the program code may be further configured to case the processor circuit to clear the first set of program instructions from the loop storage circuit, in response to detecting the second information.

In some embodiments, the method may further include inserting, into the program code, second information that identifies a second program loop included in the first program loop. The second program loop may, in various embodiments, include a second set of program instructions of the plurality of program instructions.

In the event of the first program loop including a second program loop, the modified version of the program code may be further configured to cause the processor circuit to clear the first set of program instructions from the loop storage circuit, and store the second set of program instructions in the loop storage circuit during execution of a base iteration of the second program loop. Additionally, the modified version of the program code may be further configured to cause the processor circuit to retrieve the second set of program instructions from the loop storage circuit during execution of iterations of the second program loop subsequent to the execution of the base iteration of the second program loop.

The method further includes storing the modified version of the program code (block 1604). In various embodiments, the program code is configured to cause a processor circuit, upon detection of the first program loop during execution of the modified version of the program code, to store a first set of instructions in a loop storage circuit during execution of a base iteration of the first program loop. The program code is additionally configured to cause the processor circuit to retrieve the first set of instructions from the loop storage circuit during execution of iterations of the first program loop subsequent to the execution of the base iteration of the first program loop. The method concludes in block 1605.

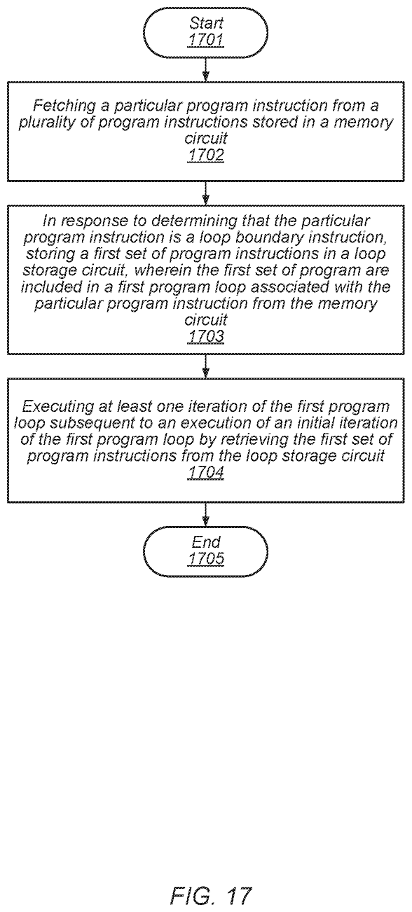

Turning to FIG. 17, a flow diagram depicting an embodiment of a method for operating a computer system that includes a loop storage circuit is illustrated. The method, which may be applied to computer system 1200 or any other suitable computer system, begins in block 1701.

The method includes fetching a particular program instruction from a plurality of program instructions stored in a memory circuit (block 1702). In various embodiments, the plurality of program instructions may be compressed as described above.

The method further includes, in response in response to determining that the particular program instruction is a loop boundary instruction, storing a first set of program instructions in a loop storage circuit (block 1703). In various embodiments, the first set of program instructions are included in a first program loop associated with the particular program instruction from the memory circuit. In some embodiments, the method may include decoding the first set of program instructions and storing decoded versions of the program instructions in the first set of program instructions in the loop storage circuit.

The method also includes executing at least one iteration of the first program loop subsequent to an execution of an initial iteration of the first program loop (block 1704). In some embodiments, executing the at least on iteration of the program loop, includes retrieving the first set of program instructions from the loop storage circuit.

The method may, in some embodiments, also include, in response to executing a final iteration of the first program loop, clearing the first set of program instructions from the loop storage circuit. The method may also include fetching a next instruction from the memory circuit.

In various embodiments, the method may further include, in response to determining that a different instruction included in the first set of program instructions is a loop boundary instruction, fetching a second set of program instructions included in a second program loop associated with the different instruction from the memory circuit. Additionally, the method may include storing the second set of program instructions in a different loop storage circuit, and executing at least one iteration of the second program loop subsequent to an execution of an initial iteration of the second program loop by retrieving the second set of program instructions from the different loop storage circuit. The method concludes in block 1705.

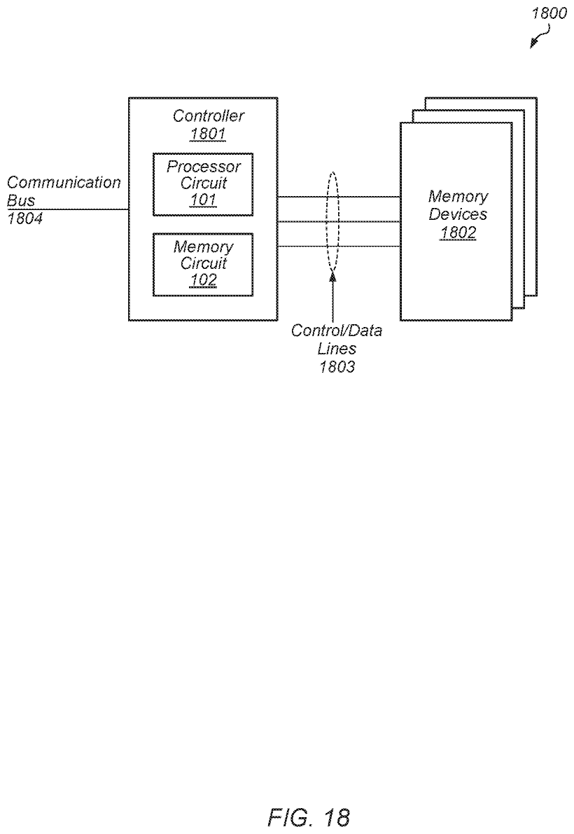

A block diagram of a storage subsystem is illustrated in FIG. 18. As illustrated, storage subsystem 1800 includes controller 1801 coupled to memory devices 1802 by control/data lines 1803. In some cases, storage subsystem 1800 may be included in a computer system, a universal serial bus (USB) flash drive, or other suitable system that employs data storage.

Controller 1801 includes processor circuit 101 and memory circuit 102. It is noted that controller 1801 may include additional circuits (not shown) for translating voltage levels of communication bus 1804 and control/data lines 1803, as well as parsing data and/or commands received via communication bus 1804 according to a communication protocol used on communication bus 1804. In some embodiments, however, memory circuit 102 may be included within memory devices 1802 rather than controller 1801.

In response to receiving a request for access to memory devices 1802 via communication bus 1804, processor circuit 101 may fetch and execute program instructions from memory circuit 102 as described above. As the fetched program instructions are executed by processor circuit 101, commands, addresses, and the like may be generated by processor circuit 101 and sent to memory devices 1802 via control/data lines 1803. Additionally, processor circuit 101, in response to executing different fetched program instructions, may receive previously stored data from memory devices 1802, and re-format the data to be sent to another functional circuit via communication bus 1804. In cases were memory devices 1802 include non-volatile memory cells, processor circuit 101 may, in response to fetching and executing particular subroutines or macros stored in memory circuit 102, manage the non-volatile memory cells by performing garbage collections, and the like.

Memory devices 1802 may, in various embodiments, include any suitable type of memory such as a Dynamic Random-Access Memory (DRAM), a Static Random-Access Memory (SRAM), a Read-Only Memory (ROM), Electrically Erasable Programmable Read-only Memory (EEPROM), or a non-volatile memory, for example. In some cases, memory devices 1802 may be arranged for use as a solid-state hard disc drive.

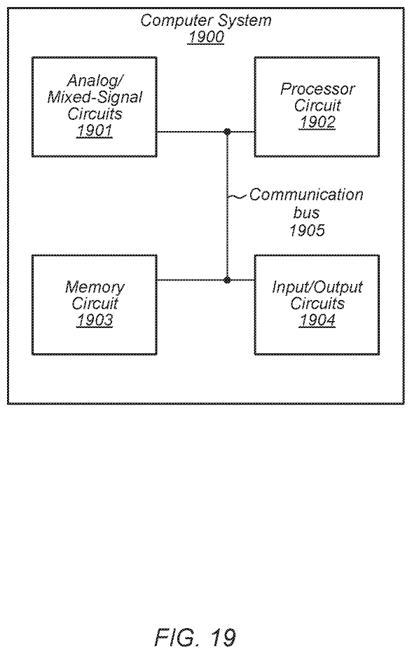

A block diagram of a computer system is illustrated in FIG. 19. In the illustrated embodiment, the computer system 1900 includes analog/mixed-signal circuits 1901, processor circuit 1902, memory circuit 1903, and input/output circuits 1904, each of which is coupled to communication bus 1905. In various embodiments, computer system 1900 may be a system-on-a-chip (SoC) and/or be configured for use in a desktop computer, server, or in a mobile computing application such as, e.g., a tablet, or laptop computer.

Analog/mixed-signal circuits 1901 may include a variety of circuits including, for example, a crystal oscillator, a phase-locked loop (PLL), an analog-to-digital converter (ADC), and a digital-to-analog converter (DAC) (all not shown). In other embodiments, analog/mixed-signal circuits 1901 may be configured to perform power management tasks with the inclusion of on-chip power supplies and voltage regulators. Analog/mixed-signal circuits 1901 may also include, in some embodiments, radio frequency (RF) circuits that may be configured for operation with wireless networks.

Processor circuit 1902 may, in various embodiments, be representative of a general-purpose processor that performs computational operations. For example, processor circuit 1902 may be a central processing unit (CPU) such as a microprocessor, a microcontroller, an application-specific integrated circuit (ASIC), or a field-programmable gate array (FPGA). In various embodiments, processor circuit 1902 may correspond to processor circuit 101 as depicted in FIG. 1, and may be configured to send fetch command 107 via communication bus 1905. Processor circuit 1902 may be further configured to receive instruction data 108 via communication bus 1905.

Memory circuit 1903 may in various embodiments, include any suitable type of memory such as a Dynamic Random-Access Memory (DRAM), a Static Random-Access Memory (SRAM), a Read-Only Memory (ROM), Electrically Erasable Programmable Read-only Memory (EEPROM), or a non-volatile memory, for example. It is noted that although in a single memory circuit is illustrated in FIG. 19, in other embodiments, any suitable number of memory circuits may be employed. It is noted that in some embodiments, memory circuit 1903 may correspond to memory circuit 102 as depicted in FIG. 1.

Input/output circuits 1904 may be configured to coordinate data transfer between computer system 1900 and one or more peripheral devices. Such peripheral devices may include, without limitation, storage devices (e.g., magnetic or optical media-based storage devices including hard drives, tape drives, CD drives, DVD drives, etc.), audio processing subsystems, or any other suitable type of peripheral devices. In some embodiments, input/output circuits 1904 may be configured to implement a version of Universal Serial Bus (USB) protocol or IEEE 1394 (Firewire®) protocol.

Input/output circuits 1904 may also be configured to coordinate data transfer between computer system 1900 and one or more devices (e.g., other computing systems or integrated circuits) coupled to computer system 1900 via a network. In one embodiment, input/output circuits 1904 may be configured to perform the data processing necessary to implement an Ethernet (IEEE 802.3) networking standard such as Gigabit Ethernet or 10-Gigabit Ethernet, for example, although it is contemplated that any suitable networking standard may be implemented. In some embodiments, input/output circuits 1904 may be configured to implement multiple discrete network interface ports.

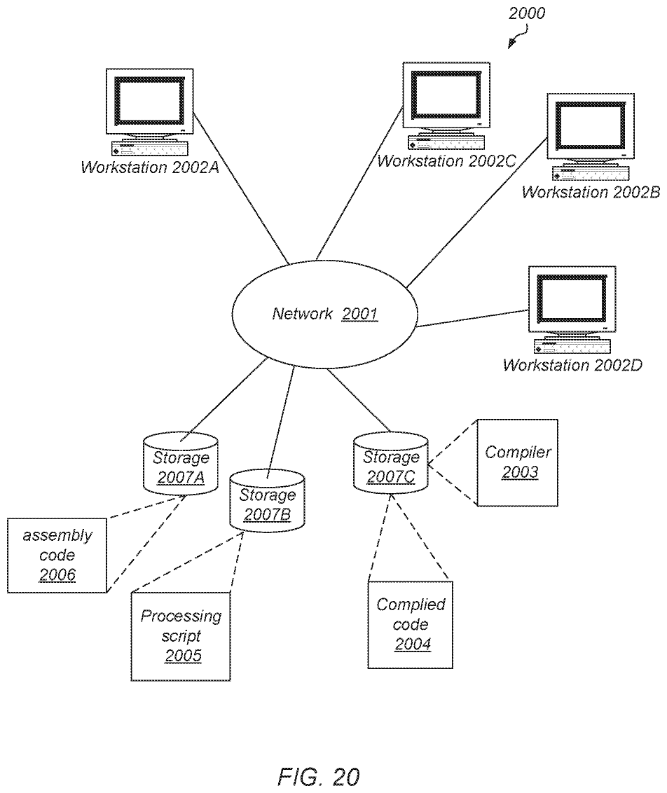

Turning to FIG. 20, a block diagram depicting an embodiment of a computer network is illustrated. The computer system 2000 includes a plurality of workstations designated 2002A through 2002D. The workstations are coupled together through a network 2001 and to a plurality of storage devices designated 2007A through 2007C. In one embodiment, each of workstations 2002A-2002D may be representative of any standalone computing platform that may include, for example, one or more processors, local system memory including any type of random-access memory (RAM) device, monitor, input output (I/O) means such as a network connection, mouse, keyboard, monitor, and the like (many of which are not shown for simplicity).

In one embodiment, storage devices 2007A-2007C may be representative of any type of mass storage device such as hard disk systems, optical media drives, tape drives, ram disk storage, and the like. As such, program instructions for different applications may be stored within any of storage devices 2007A-2007C and loaded into the local system memory of any of the workstations during execution. As an example, assembly code 2006 is shown stored within storage device 2007A, while processing script 2005 is stored within storage device 2007B. Further, compiled code 2004 and compiler 2003 are stored within storage device 2007C. Storage devices 2007A-2007C may, in various embodiments, be particular examples of computer-readable, non-transitory media capable of storing instructions that, when executed by a processor, cause the processor to implement all or part of various methods and techniques described herein. Some non-limiting examples of computer-readable media may include tape reels, hard drives, CDs, DVDs, flash memory, print-outs, etc., although any tangible computer-readable medium may be employed to store processing script 2005.

In one embodiment, processing script 2005 may generate a compressed version of assembly code 2006 using operations similar to those described in FIG. 6 and FIG. 7. In various embodiments, processing script 2005 may replace duplicate instances of repeated sets of program code by unconditional flow control program instructions to reduce the size of assembly code 2006. Compiler 2003 may then compile the compressed version of assembly code 2006 to generate compiled code 2004. Following compilation, compiled code 2004 may be stored in a memory circuit, e.g., memory circuit 102, that is included in any of workstations 2002A-2002D.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. An apparatus, comprising:
a memory circuit configured to store a plurality of program instructions included in program code;
a processor circuit configured to:
fetch a particular program instruction of the plurality of program instructions from the memory circuit;
in response to a determination that the particular program instruction is a loop boundary instruction, store a first set of program instructions in a first loop storage circuit, wherein the first set of program instructions are included in a first program loop associated with the particular program instruction; and
execute at least one iteration of the first program loop subsequent to an execution of an initial iteration of the first program loop, wherein to execute the at least one iteration of the first program loop, the processor circuit is further configured to retrieve the first set of program instructions from the first loop storage circuit.

2. The apparatus of claim 1, wherein the processor circuit is further configured to:
in response to an execution of a final iteration of the first program loop, clear the first set of program instructions from the first loop storage circuit; and
fetch a next program instruction from the memory circuit.

3. The apparatus of claim 1, wherein the processor circuit is further configured, in response to a determination that a different instruction included in the first set of program instructions is a loop boundary instruction, to:
fetch a second set of program instructions included in a second program loop associated with the different instruction from the memory circuit;
store the second set of program instructions in a second loop storage circuit; and
retrieve the second set of program instructions from the second loop storage circuit; and
execute at least one iteration of the second program loop subsequent to an execution of an initial iteration of the second program loop.

4. The apparatus of claim 1, wherein the processor circuit is further configured to:
decode the first set of program instructions; and
store decoded versions of the program instructions included in the first set of program instructions in the first loop storage circuit.

5. The apparatus of claim 1, wherein the processor circuit is further configured, in response to a determination that a given instruction of the first set of program instructions is a conditional execution instruction, evaluate, during an execution of a given iteration of the first program loop, a condition specified by the conditional execution instruction.

6. The apparatus of claim 1, wherein the first loop storage circuit includes a content-addressable memory circuit.

7. A method, comprising:
receiving program code that includes a plurality of program instructions;
inserting, into the program code, first information that identifies a first program loop included in the plurality of program instructions to generate a modified version of the program code, wherein the first program loop includes a first set of program instructions of the plurality of program instructions;
storing the modified version of the program code; and
wherein the modified version of the program code is configured to cause a processor circuit, upon detection of the first program loop during execution of the modified version of the program code, to store the first set of program instructions in a loop storage circuit during execution of a base iteration of the first program loop, and retrieve the first set of program instructions from the loop storage circuit during execution of iterations of the first program loop subsequent to the execution of the base iteration of the first program loop.

8. The method of claim 7, wherein inserting, into the program code, the first information that identifies the first program loop includes inserting an identification instruction into the plurality of program instructions.

9. The method of claim 7, wherein inserting, into the program code, the first information that identifies the first program loop includes modifying a particular instruction of the plurality of program instructions to identify the particular instruction as a first instruction of the first program loop.

10. The method of claim 7, further comprising, replacing one or more program instructions in the first set of program instructions with a conditional execution instruction.

11. The method of claim 7, further comprising:
inserting, into the program code, second information that identifies an end to the first program loop; and
wherein the modified version of the program code is further configured to cause the processor circuit to clear the first set of program instructions from the loop storage circuit, in response to detecting the second information.

12. The method of claim 7, further comprising inserting, into the program code, second information that identifies a second program loop included in the first program loop, wherein the second program loop includes a second set of program instructions of the plurality of program instructions.

13. The method of claim 12, wherein the modified version of the program code is further configured to cause the processor circuit to:
clear the first set of program instructions from the loop storage circuit;
store the second set of program instructions in the loop storage circuit during execution of a base iteration of the second program loop; and
retrieve the second set of program instructions from the loop storage circuit during executions of iterations of the second program loop subsequent to the execution of the base iteration of the second program loop.

14. A system, comprising:
a processor circuit configured to generate a fetch command; and
a memory circuit, external to the processor circuit and including a memory array configured to store a plurality of program instructions included in compacted program code, wherein the memory circuit is configured to:
retrieve a given program instruction of the plurality of program instructions from the memory array based, at least in part, on receiving the fetch command;
in response to a determination that the given program instruction is a first type of instruction, retrieve, from the memory array, a subset of the plurality of program instructions beginning at an address included in the given program instruction; and
send the subset of the plurality of program instructions to the processor circuit.

15. The system of claim 14, further comprising a loop storage circuit, wherein the processor circuit is further configured to:
fetch a particular program instruction of the plurality of program instructions from the memory circuit;
in response to a determination that the particular program instruction is a loop boundary instruction, store a first set of program instructions in a loop storage circuit, wherein the first set of program instructions are included in a first program loop associated with the particular program instruction from the memory circuit; and
execute at least one iteration of the first program loop subsequent to an execution of an initial iteration of the first program loop, wherein to execute the at least on iteration of the first program loop, the processor circuit is further configured to retrieve the first set of program instructions from the loop storage circuit.

16. The system of claim 15, wherein the processor circuit is further configured to:
in response to executing a final iteration of the first program loop, clear the first set of program instructions from the loop storage circuit; and
fetch a next program instruction from the memory circuit.

17. The system of claim 15, wherein the processor circuit is further configured to:
store the first set of program instructions in the loop storage circuit using a first range of addresses; and
in response to a determination that a different instruction included in the first set of program instructions is a loop boundary instruction, to:
fetch, from the memory circuit, a second set of program instructions included in a second program loop associated with the different instruction;
store the second set of program instructions in the loop storage circuit using a second range of addresses different than the first range of addresses;
retrieve the second set of program instructions from the loop storage circuit; and
execute at least one iteration of the second program loop subsequent to an execution of an initial execution of the second program loop.

18. The system of claim 15, wherein the loop storage circuit includes a content-addressable memory circuit.

19. The system of claim 18, wherein the processor circuit is further configured to;
decode the first set of program instructions; and
store decoded versions of the program instructions included in the first set of program instructions in the loop storage circuit.

20. The system of claim 19, wherein the processor circuit is further configured to:
generate a plurality of addresses;
fetch the first set of program instructions using the plurality of addresses; and
store a given program instruction of the first set of program instructions and a corresponding one of the plurality of addresses in the loop storage circuit.
